(19) United States
(12) Patent Application Publication
(10) Pub. No.: US 2009/0139203 A1
(43) Pub. Date: Jun. 4, 2009

(54) METHOD AND APPARATUS FOR TAILORING THE EQUIVALENCE RATIO IN A VALVED PULSE DETONATION COMBUSTOR

(75) Inventors: Adam Rasheed, Glenville, NY (US); Ross Hartley Kenyon, Waterford, NY (US); David Chapin, Niskayuna, NY (US); Kevin Hinckley, Saratoga Springs, NY (US); Pierre Francois Pinard, Delmar, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/271,091

(22) Filed: Nov. 14, 2008

Related U.S. Application Data
(60) Provisional application No. 60/988,171, filed on Nov. 15, 2007.

(51) Int. Cl. F02K 7/02

(52) U.S. Cl. 60/247

(57) ABSTRACT

A pulse detonation combustor assembly contains at least one PDC tube, a mechanical air flow valve which directs an air flow into the PDC tube, where the mechanical air flow assembly changes a rate of the air flow into the PDC tube during a fill stage of the PDC tube. The assembly also contains a fuel flow control valve which directs fuel to the PDC tube and changes the rate of the fuel flow into PDC tube. By controlling the flow of the fuel and air into the PDC tube the equivalence ratio profile of the PDC tube can be tailored and controlled.

### PRIORITY

This invention claims priority to U.S. Provisional Application 60/988,171 filed on Nov. 15, 2007, the entire disclosure of which is incorporated herein by reference.

### BACKGROUND OF THE INVENTION

This invention relates to pulse detonation systems, and more particularly, to a method and apparatus for tailoring the equivalence ratio in a valved pulse detonation combustor.

With the recent development of pulse detonation combustors (PDCs) and engines (PDEs), various efforts have been underway to use PDC/Es in practical applications, such as in aircraft engines and/or as means to generate additional thrust/propulsion. Further, there are efforts to employ PDC/E devices into “hybrid” type engines which use a combination of both conventional gas turbine engine technology and PDC/E technology in an effort to maximize operational efficiency. It is noted that the following discussion will be directed to “pulse detonation combustors” (i.e. PDCs). However, the use of this term is intended to include pulse detonation engines, and the like.

Because of the recent development of PDCs and an increased interest in finding practical applications and uses for these devices, there is an increasing interest in increasing their operational and performance efficiencies, as well as incorporating PDCs in such a way so as to make their use practical.

As is widely known, PDCs operate by detonating a fuel/oxidizer (usually air) mixture in a PDC tube. The detonation creates a significant pressure rise and velocity increase, such that the detonated fuel/oxidizer mixture is directed out of the PDC tube at a very high pressure and velocity, providing significant thrust and/or work energy. In most PDCs, the fuel and oxidizer is introduced into the PDC detonation chamber and/or tube via mechanical valves. Ideally, mechanical valves would open and close nearly instantaneously or at a similar rate based on input signals (or whatever is used to control them). Alternatively, a fuel flow profile is provided over the transient operation of an air valve, for example in a duration of 4 to 8 ms. This would allow for ideal control of the fuel and oxidizer flow into the PDC to optimize the detonation and operation of the PDC.

However, it is also known that with mechanical valves this “ideal” operation can not be realized. Because of this most conventional valving methods result in a fuel/oxidizer flow into the PDC which is less than optimal. Specifically, the equivalence ratio within the PDC is not controlled such that detonation and performance can be optimized.

Because the control of the equivalence ratio within a PDC prior to detonation is important in optimizing the detonation and operation of the PDC, and because ideal control of mechanically valved systems can not be achieved, there exists a need for an improved method of implementing mechanical fuel and oxidizer valving in PDCs.

### SUMMARY OF THE INVENTION

In an embodiment of the present invention, at least one pulse detonation combustor tube contains an air flow valve which directs an air flow into the at least one pulse detonation combustor tube, where the air flow assembly changes a rate of change of the air flow into the pulse detonation combustor tube during a fill stage of the pulse detonation combustor tube and a fuel flow control valve which directs fuel to the at least one pulse detonation combustor tube. The air flow valve controls the air flow rate of change with respect to a fuel flow rate of change provided by the fuel flow control valve to control the equivalence ratio within the pulse detonation combustor tube.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

As used herein, “engine” means any device used to generate thrust and/or power.

### BRIEF DESCRIPTION OF THE DRAWINGS

The advantages, nature and various additional features of the invention will appear more fully upon consideration of the illustrative embodiment of the invention which is schematically set forth in the figures, in which:

FIGS. 1A to 1C show graphical representations of equivalence ratio in an ideal fuel and oxidizer flow;

FIGS. 2A to 2C show graphical representations of equivalence ratio when a realistic oxidizer flow is combined with an ideal fuel flow;

FIGS. 3A to 3C show graphical representations of equivalence ratio when both fuel and oxidizer flow are tailored in accordance with a embodiment of the present invention;

FIGS. 4A to 4C show graphical representations of equivalence ratio when both fuel and oxidizer flow are tailored in accordance with another embodiment of the present invention;

FIG. 5 shows a diagrammatical representation of a oxidizer inlet valve in accordance with an exemplary embodiment of the present invention;

FIGS. 6A and 6B show graphical representations of air flow in accordance with various embodiments of the present invention;

FIG. 7 shows a diagrammatical representation of a oxidizer inlet valve in accordance with another exemplary embodiment of the present invention;

FIG. 8 shows a diagrammatical representation of a oxidizer inlet valve in accordance with a further alternative exemplary embodiment of the present invention;

FIG. 9 shows a diagrammatical representation of a fuel flow control system in accordance with an exemplary embodiment of the present invention;

FIG. 10 shows a diagrammatical representation of a fuel and oxidizer flow control system in accordance with an exemplary embodiment of the present invention; and

FIG. 11 shows a diagrammatical representation of a PDC system in accordance with an exemplary embodiment of the present invention.

### DETAILED DESCRIPTION OF THE INVENTION

The present invention will be explained in further detail by making reference to the accompanying drawings, which do not limit the scope of the invention in any way.

Exemplary embodiments of the present invention are directed to methods and apparatus to achieve optimized pulsed operation of a PDC with the use of mechanical valves controlling both the fuel and oxidizer flow to the PDC to achieve an equivalence ratio which is optimized for PDC detonation and performance. This is accomplished by using the valving to control the fuel and air flow rates as needed to achieve the desired spatial equivalence ration within a PDC prior to detonation to optimize desired performance. It is noted that although the following description may refer to “air” in most instances as the oxidizer, the present invention is not limited in this regard, and the use of “air” is not intended to be limiting. Other oxidizers, such as oxygen can be used.

As in generally understood, “equivalence ratio” of a PDC is the ratio of the fuel-to-oxidizer ratio to the stoichiometric fuel-to-oxidizer ratio. Thus, an equivalence ratio of 1 means that the fuel-to-oxidizer ratio in the PDC is the same as the stoichiometric fuel-to-oxidizer ratio for the given conditions. When the equivalence ratio is higher than 1 the fuel-to-oxidizer ratio is “rich,” and when the equivalence ratio is less than 1 the fuel-to-oxidizer ratio is “lean.” Based on different operational conditions and desired performance characteristics it is desirable to be able to accurately control and/or change the equivalence ratio with a PDC so to optimize detonation and performance based on the existing conditions. By optimizing and/or accurately controlling the equivalence ratio the PDC combustion efficiency is improved, the emissions are minimized and the deflagration to detonation transition (“DDT”) is minimized. Thus, the overall resultant operation of a PDC can be optimized. In a further embodiment the equivalence ratio is controlled over a length of the tube. In such an embodiment, for example, the mixture is rich at the head end of the PDC and lean over the length of tube to reduce emissions and increase efficiency.

As used herein, spatial equivalence ratio or spatial profile is intended to mean the equivalence ratio physically within the PDC tube.

This control of the equivalence ratio can be achieved by a number of means and methods. The present invention accomplishes this control through the design and/or control of mechanical fuel and oxidizer valves to control and/or change the opening/closing rates of the valves and/or the ramp up/down profiles of the fuel and oxidizer flow rates. By accomplishing this through the use of the non-limiting exemplary embodiment described below, it becomes possible to tailor, tune and/or change the equivalence ratio distribution within a PDC tube during the fill stage to optimize combustion and detonation efficiency, minimize emissions and minimize DDT length of the PDC. That is, not only does the present invention allow for precise control and/or change of the equivalence ratio employed within the PDC during operation, but exemplary embodiments of the present invention allow for the control and/or change of the equivalence ratio profile within the PDC. Stated differently, embodiments of the present invention can control the fuel and oxidizer flow such that the equivalence ratio at different locations within the PDC, prior to detonation, is different. This will be discussed further below.

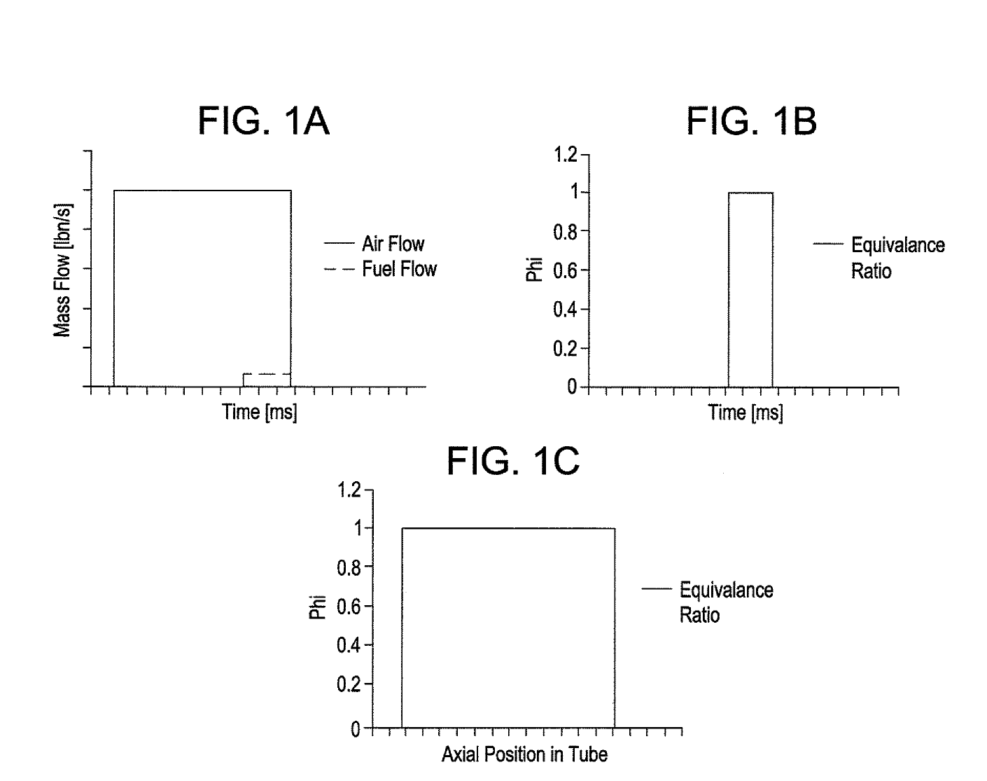

As an initial matter it is noted that the vertical axis in FIGS. 1B-1C; 2B-2C; 3B-3C; and 4B-4C are identified as “Phi,” which for the purposes of these graphs is the equivalence ratio.

Turning now to FIGS. 1A through 1C, these figures graphically depict the operation of a PDC in an ideal situation in which the valves controlling the flow of oxidizer and fuel can open and close instantaneously. In such an ideal situation, as shown in FIG. 1A, the air and fuel flow increase and decrease at the same or similar rates such that a uniform equivalence ratio can be distributed within the PDC. That is, if an equivalence ratio of 1 is desired, this can be achieved through the entire fill process of the PDC (see FIG. 1B) and axially within the PDC the equivalence ratio is constant (see FIG. 1C).

However, as described above, this “ideal” operation can not be achieved. Depending on the configuration, operation and limitations of the mechanical valving being used the air and fuel flow profiles can be such that the desired equivalence ratio is either not reached, or not reached in an efficient operational manner. Further, because of the different types of valving being used for fuel and air flow, and their respective operational parameters and their limitations, it is difficult or not possible to obtain the optimal or desired flow rates for fuel and/or air.

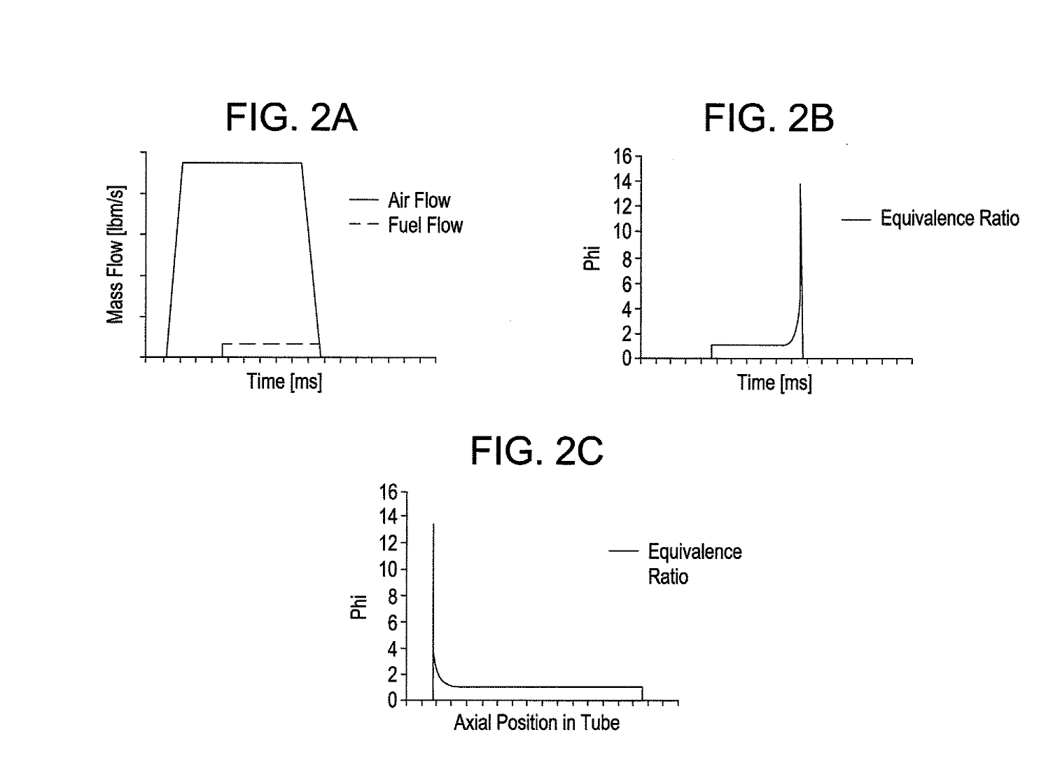

This is illustrated in FIGS. 2A through 2C, which graphically depict the operation of a PDC in a situation in which air flow is controlled by a realistic flow control device and the fuel flow is controlled ideally. As shown, the mass flow rate of the air ramps up (FIG. 2A) as opposed to instantly reaching the desired flow rate. Because of this, the equivalence ratio profile in the PDC is not uniform (see FIGS. 2B and 2C). In fact, the profiles are severely skewed in that the equivalence ratio severely peaks at the end of the fill process. This results in a spatial distribution of equivalence ratio which is rich at the fill location within the PDC, but has a relatively low equivalence ratio at most axial positions away from the fill location. (See FIG. 2C). This operational profile is inefficient.

It is noted that although FIG. 2A shows an “ideal” fuel flow rate, in that the ramp up/down is instantaneous, this can be considered to be relatively demonstrative of some fuel flow systems used in known PDC operations in which fuel flow is started and stopped as quickly as possible. (Thus resulting in a near vertical ramp up/down fuel flow profile).

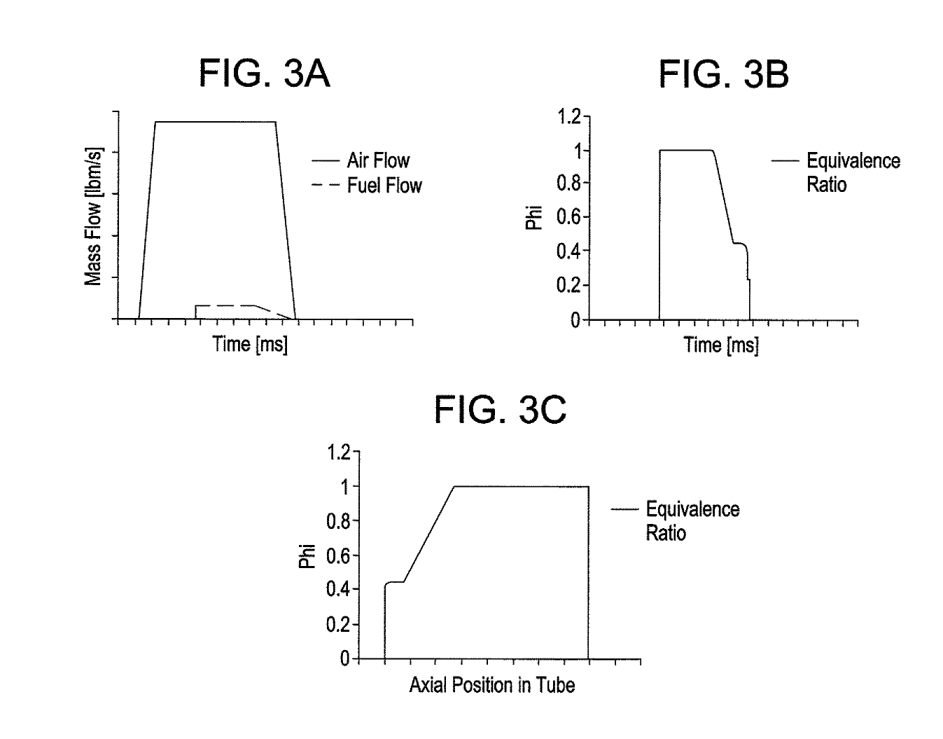

FIGS. 3A through 3C graphically depict the operation of a PDC in accordance with an embodiment of the present invention, in which the valves controlling the flow of oxidizer and fuel are controlled to tailor the equivalence ratio profile such that an optimal/desired PDC performance is achieved. As shown in FIG. 3A the air flow is controlled normally—that is having a ramp up and ramp down time to a desired flow rate. However, unlike the FIG. 2A the fuel flow ramps down in a controlled manner, and is not desired to be near instantaneous. By controlling the fuel and air flows in this manner a more controlled equivalence ratio profile can be achieved. As shown in FIGS. 3B and 3C, the resultant equivalence ratio profile is lean near the end of the PDC fill process. Thus, if this profile is desired for operational/performance purposes, it can not be achieved by employing the exemplary embodiments described below.

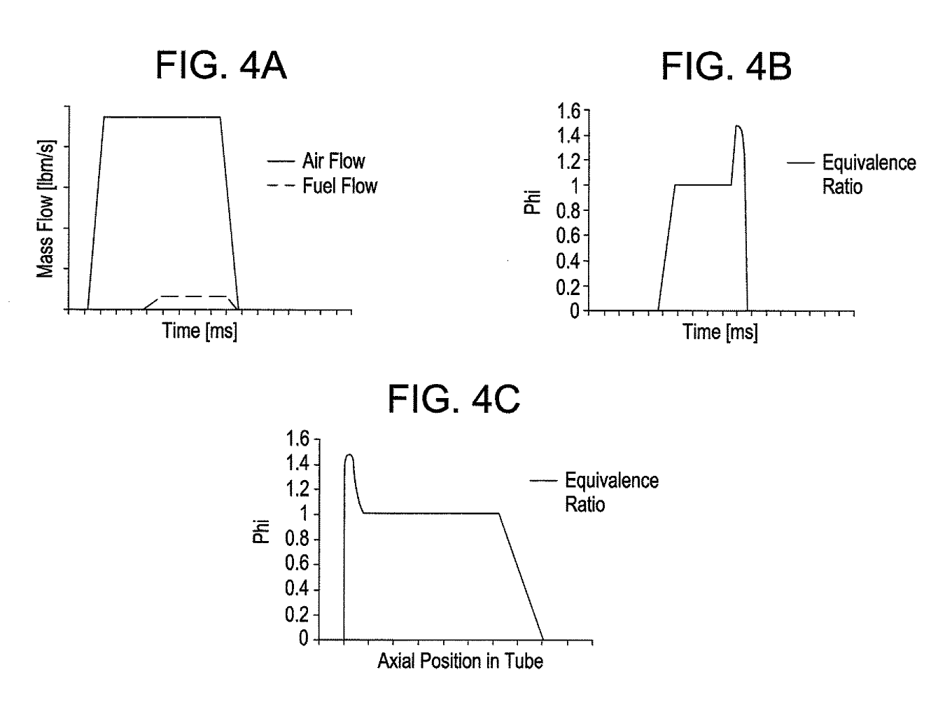

In an exemplary embodiment, an equivalence ratio profile is provided where the equivalence ratio spatial profile is at or near 1 within the PDC tube, with a slightly fuel fuel-rich region near the ignition source in order to optimize the DDT process. This can be accomplished by controlling the air and fuel valves such that there is an equivalence ratio of at or near 1 for the majority of the PDC filling time period, but then becomes richer at the end of the PDC filling time period. This profile is shown in FIGS. 4A through 4C.

FIGS. 4A through 4C show an equivalence profile achieved by various embodiments of the present invention, where the air flow and fuel flow are controlled so as to achieve a desired profile which optimizes the PDC performance. As shown in FIG. 4A, this embodiment employs a fuel flow profile which provides a controlled ramp up and ramp down, rather than at or near instantaneous. These flow profiles provide for an equivalence ratio profile which is at or near 1 for the majority of the profile but having a richer profile at the end of the fill stage. But, unlike the FIG. 2C embodiment, there is not a dramatic spike in the equivalence profile resulting in an equivalence ratio at the end of the fill process which is considerably higher (over 10 times) than the equivalence ratio of the remainder axial positions within the PDC.

In an exemplary embodiment of the present invention, the equivalence ratio profile is maintained constant for at least 50% of the duration of the fill time. In another embodiment of the present invention, the equivalence ratio profile is maintained constant for at least 90% of the fill time. In another embodiment, the length of the PDC having a rich mixture is as short as possible, but still allow for ignition and flame acceleration.

In a further exemplary embodiment, the equivalence ratio profile is controlled such that the equivalence ratio is between 1 and 2 within the last portion of the fill time period. For the purposes of the present invention, the “last portion of the fill time period” is intended to mean the last 1 to 10% of the fill time period of the PDC operation, where the fill time period is the stage of operation in which the PDC is being filled with the fuel and oxidizer combination used for operation. This expression should not be interpreted as “at the end” of the fill time period because, as described above, the flow rates are not instantaneously controlled so even though the profile at the end of the fill time period shows a steep decline of equivalence ratio (see FIG. 4C).

In a further embodiment, the equivalence ratio profile is controlled such that the equivalence ratio is controlled to be between 1 and 4 within the last portion of the fill stage.

In an exemplary embodiment, the majority of the length of the of the length of the PDC tube has an equivalence ratio between 0.5 and 1 and the equivalence ratio at the point/points of ignition is in the range of 0.9 to 2. In a further exemplary embodiment, the equivalence ratio is relatively constant over the entire length of the PDC tube and in the range of 0.6 to 1.

It is noted that the above discussions have been done contemplating that the oxidizer (e.g., air) remains constant throughout the entire fill process. That is that air (for example) is used throughout the entire fill process. However, the present invention is not limited in that regard. Specifically, in exemplary embodiments of the present invention, a different oxidizer can be used in addition to the primary oxidizer or as a replacement to the primary oxidizer during various stages during the fill stage. For example, in an embodiment in which air is the primary oxidizer, pure oxygen can be injected at various points during the fill stage to further affect/control the equivalence ratio to achieve desired performance. (It is noted that the introduction of the oxygen affects the equivalence ratio, regardless of whether or not it is being used in addition to or as a replacement for air, because it changes the stoichiometric fuel-to-oxidizer ratio).

In an exemplary embodiment of the present invention, a small amount of oxygen is injected near the ignition source location at the end of the fill stage, and can be used to make the fuel-to-oxidizer mixture more detonable. By adding oxygen, rather than simply replacing the air with oxygen, an increased pressure plateau can be achieved at the end of the fill stage, resulting in increased PDC chamber pressure, which can be beneficial for detonation and performance of the PDC. This is due to the fact that different fuel-oxidizer mixtures have different Chapman-Jouget (CJ) pressures, that is the maximum pressure achieved during detonation. As is known, plateau pressure is normally a function of CJ pressure, and CJ pressure and temperature is higher for a hydrocarbon-oxygen mixture than for a hydrocarbon-air mixture. Thus, the use of oxygen can provide faster kinetics and a higher temperature ratio.

Turning now to the remaining figures, various non-limiting exemplary embodiments of mechanical valving systems and controls will be described which can be used to control the respective fuel and air flow rates and create the equivalence ratio profile control as described above.

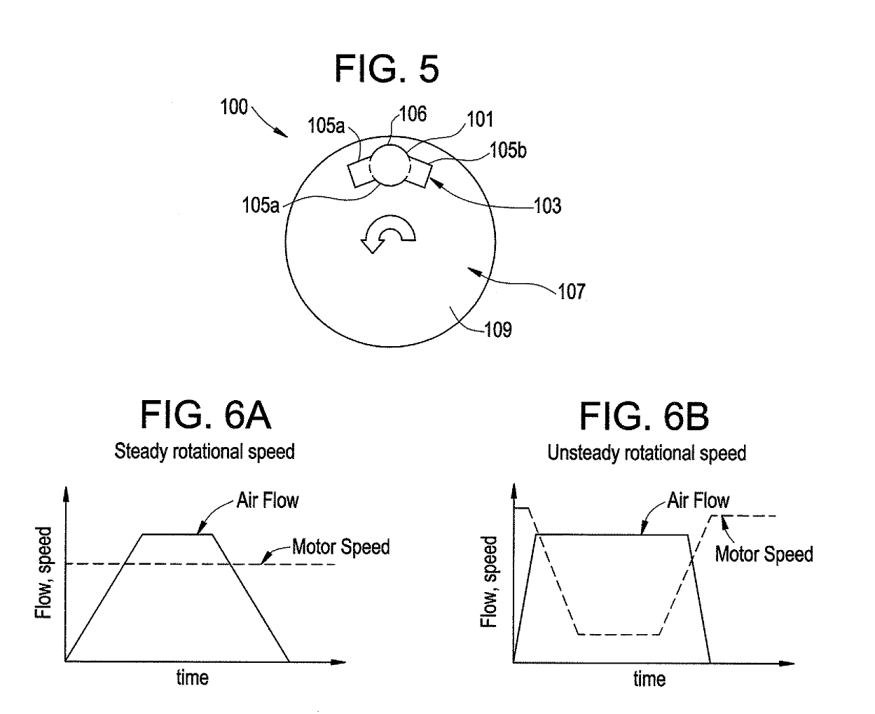

FIG. 5 depicts a diagrammatical representation of an upstream end of a PDC assembly 100 in accordance with an exemplary embodiment of the present invention. The assembly 100 comprises at least one PDC tube 101 (having the desired PDC components such as chamber, blow down tube and exhaust nozzle, or the like) and valve structure 107. The valve structure 107 is a mechanical valve structure having a portion 109. As shown, in FIG. 5, the portion 109 rotates about an axis. It is noted that although the portion 109 is shown having a round structure the present invention is not limited to this shape or configuration. The portion 109 is rotated by any known means. For example, the portion 109 may be connected to a shaft which is turned by a motor or the like. Alternatively, the portion can be rotated by a gear structure engaged on a portion 109 through known means. The present invention is not limited in this regard.

As shown, the portion 109 contains at least one air valve port 103. The air valve port 103 is positioned on the portion 109 so as the portion 109 rotates the air valve port 103 opening matches the inlet to the PDC tube 101 allowing oxidizer to flow into the PDC tube 101. For purposes of FIG. 5, the flow of the oxidizer is directed at the page.

It is noted that the rotating portion 109 is shown herein as a disk. However, the present invention is not limited in this regard. In other embodiments, the portion 109 can be a rotating can design which is concentric with the PDC. Alternatively, the portion 109 can be any other rotating type device having an opening through which air, fuel and/or a fuel air mixture passes to enter the PDC tube 101.

To effect control of the air flow profile (this affecting the equivalence ratio profile) the air valve port 103 has an opening which is shaped to optimize the equivalence ratio profile of the PDC tube 101 and thus its performance. Specifically, the port 103 has a leading edge portion 105a and a trailing edge portion 105b which extend from a main portion 106 of the port 103. The main portion 106 has a shape which corresponds to the shape of the inlet of the PDC tube 101. As shown in the embodiment in FIG. 5, the main portion 106 has a shape such that when the main portion is positioned directly adjacent the PDC tube 101 the inlet of the PDC tube 101 fits within or matches the main portion 106. In an exemplary embodiment of the present invention, the opening of the main portion substantially dimensionally matches the inlet of the PDC tube 101 (as shown). However, in an alternative embodiment it is contemplated that the main portion 106 can be slightly larger or smaller than the inlet of the PDC tube 101, or has a slightly different shape without deviating from the spirit and scope of the present invention.

Extending from the leading edge (in a rotational sense) of the main portion 106 is a leading edge portion 105a. This leading edge portion 105a engages with the inlet of the PDC tube 101 first. Thus, the geometry of the leading edge portion 105a aids in defining the equivalence ratio profile in the PDC tube 101. Specifically, in the present invention, the geometry of the leading edge portion 105a can be specifically tailored to control the air flow into the PDC tube 101 at the beginning of the fill stage to achieve the desired equivalence ratio profile at the beginning of the fill and up until the main portion 106 engages the PDC tube 101 inlet. The shape of the leading edge portion 105a shown in FIG. 5 is merely an exemplary embodiment. Other geometries can be used depending on the desired equivalence ratio profile, performance, design and rotational speed.

At the trailing edge (in a rotational sense) of the main portion 106 is a trailing edge portion 105b which is the last portion of the port 103 to engage the inlet of the PDC tube 101. Similar to the leading edge portion 105a, the geometry of the trailing edge portion 105b dictates the equivalence ratio profile at the end of the fill stage. Thus, the geometry of the trailing edge portion 105b can be selected to dictate the desired equivalence ratio at the end of the fill stage. In an exemplary embodiment, the trailing edge portion 105b has the same geometry as the leading edge portion 105a. In this embodiment the air flow profile will be symmetrical at its beginning and end (assuming the air supply flow rate remains constant). In another embodiment the trailing edge portion 105b geometry is different than that of the leading edge portion 105a, to obtain a different air flow profile at the end of the fill stage.

As shown in the embodiment of FIG. 5 both the leading edge of the leading edge portion 105a and the trailing edge of the trailing edge portion 105b have a linear surface. That is the leading most of the and trailing most edges of the port 103 have a straight line configuration, where the straight line represents a portion of a radial line drawn through the center of the portion 109.

In further exemplary embodiments, one of the trailing edge and leading edge portions are omitted altogether. For example, if it was desired to have the air flow rate peak as quickly as possible at the beginning of the fill stage (to obtain a desired equivalence ratio) the leading edge portion 105a can be omitted such that the main portion 106 is the first to engage the inlet of the PDC tube 101. Although the air flow rate will not appear as an “ideal” flow rate (because the leading edge of the main portion 106 takes time as it travels across the opening of the inlet to the PDC tube 101) the flow rate increase at the beginning of the fill will be steeper than those embodiments having a leading edge portion 105a. Of course, those skilled in the art, coupled with the knowledge set forth herein, would be able to choose geometries and configurations of the port 103 to achieve the desired air flow rates, equivalence ratio profiles and performance as desired.

Depending upon the desired operational frequency of the PDC tube 101 and the rate of rotation of the portion 109, it is contemplated that some embodiments of the present invention will have more than one port 103 on the portion. For example, in an embodiment of the invention, the portion 109 has two ports 103 which are positioned 180 degrees from each other. In this embodiment, the PDC tube 101 goes through two operational cycles for a single rotation of the portion 109. This embodiment can be useful when it is desired to rotate the portion at slower speeds, than would be required with a single port 103.

In a further exemplary embodiment, a plurality of PDC tubes 101 is employed in the PDC assembly 100. This embodiment, allows for the overall increase in the operational frequency of the assembly 100, without increasing the operational frequency of any one PDC tube 101. For example, it is contemplated that three PDC tubes 101 are positioned radially with respect to a centerline of the portion 109 such that as the portion 109 is rotated the port 103 will engage the three PDC tubes 103 separately, such that each of the PDC tubes 101 will be operating at the same frequency, but out of phase with each other. Of course, the present invention is not limited to the use of one or three PDC tubes 101, as other quantities are also contemplated.

It is noted that the above discussion has been directed to an exemplary embodiment of the present invention in which the rotational speed of the portion 109 is constant. However, in a further exemplary embodiment of the present invention, the rotational speed of the portion 109 can be changed to change/tailor the equivalence ratio profile in the PDC tube 101 to match desired operational and performance parameters.

Because it is contemplated that the PDC assembly 100 of the present invention can be used in various, diverse applications, it is recognized that the operational parameters of the PDC assembly 100 will change through its operational envelope. For example, if the PDC assembly 100 were used in an aircraft engine the operational characteristics of the PDC tubes 101 may need to change through the flight profile. As an example, it may be necessary to change the operational frequency of the PDC tube 100 and/or the equivalence ratio profile within the PDC tube 101 to achieve optimal performance. Therefore, in an exemplary embodiment of the present invention the rotational speed of the portion can be changed. The rotational speed can be slowed or increased based on the desired performance and/or equivalence ratio profile.

In fact, it is contemplated that in embodiments of the present invention the rotational speed of the portion 109 will change within each rotation of the portion 109. Of course, in some exemplary embodiments, the rotational speed of the portion can be increased or decreased to change the operational frequency of the PDC tube 101. (Because of this it may be desirable to design the geometry of the port 103 so as to be efficient and optimal throughout the entire operational envelope of the PDC assembly.)

However, in other operational situations it may be desirable to maintain the same PDC tube 101 operational frequency, but have a changed air flow and/or equivalence ratio profile. When the geometry of the port 103 is fixed, as shown in FIG. 5, this is accomplished by changing the rotational speed of the portion 109 within each rotation. This can be seen in FIGS. 6A and 6B.

FIG. 6A depicts an exemplary air flow profile using a steady rotational speed. As can be seen, because of the geometry of the port 103 (that is its leading and trailing edge portions and its main portion) the air flow profile ramps up, plateaus and then ramps down to provide a set flow profile. In FIG. 6B a different air flow profile is achieved by varying the rotational speed of the portion during a rotation. Specifically, as shown, the rotational speed of the portion 109 prior to the port 103 engaging the inlet of the PDC tube 101 is faster than in 6A. This speed is maintained as the leading edge portion 105a engages with the inlet portion of the PDC tube 101 resulting in an increased slope of the flow rate at the beginning of the profile. Then the rotational speed of the portion is slowed so that the main portion 106 is engaged with the inlet of the PDC tube 101 for a longer period of time. Then as the trailing edge portion 105b engages the inlet of the PDC tube 101 the rotational rate is increased again causing a sharp drop off in flow rate (see FIG. 6B). The overall result is an increase in the amount of air flow into the PDC tube 101 for a given cycle, and this can be achieved without changing the operational frequency of the PDC tube 101. Assuming that fuel flow rates were unchanged, this change will result in a change in the equivalence ratio profile. Thus, employing rotational speed changes can allow for the changing of the equivalence ratio profile within the PDC tube 101. The changing of the rotational speed of the portion 109 can be implemented by using a stepper motor control, torsional links on the driveshaft of the portion 109 with controlled oscillation and/or using linear springs arranged tangentially, such as like a clutch mechanism, and can be controlled by any known methodology, such as with a computer controlled system using various user inputs and/or feedback controls.

It is noted that in further exemplary embodiments, in addition to the use of the valve structure 107 to change the air flow profile it is contemplated that the rate of flow from the air flow source can be changed.

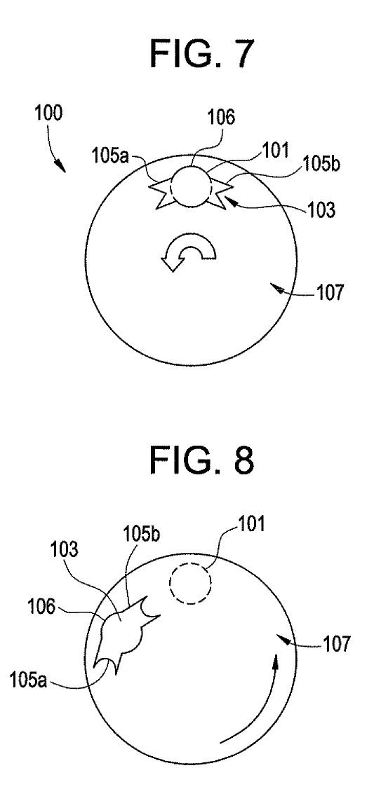

FIG. 7 depicts another embodiment of the geometry of the port 103. In this embodiment each of the leading edge of the leading edge portion 105a and the trailing edge of the trailing edge portion 105b has a concave triangular contour. This embodiment will provide a steeper air flow profile than the embodiment depicted in FIG. 5.

FIG. 8 depicts a further exemplary embodiment of the port 103. In this embodiment, the each of the leading edge of the leading edge portion 105a and the trailing edge of the trailing edge portion 105b has a concave circular contour. The circular contours match the radius of the inlet of the PDC tube 101. This embodiment provides the steepest opening/closing profile for the air flow into the PDC tube 101. This is because the leading edge and trailing edge portions 105a/b provide the most blockage of the inlet of the PDC tube 101 until the main portion 106 engages with the inlet of the PDC tube 101.

It is noted that although the above discussion has focused valve structures 107 using a portion 109 having a port 103. The control/tailoring of the equivalence ratio profile of the present invention can be achieved via other means.

Specifically, although not shown, the structures 107 can be replaced with rotating cylinders/cones having similarly designed openings to the ports 103.

Additionally, the present invention contemplates the use of electrically controlled/activated solenoid valves. Because the use of solenoid valves are known to those of skill in the art it is unnecessary to depict the valves in the figures. Those of ordinary skill in the art are familiar with the use of solenoid valves to control the flow of air, fuel, etc. By employing electrically controlled solenoid valves, the opening and closing times of the valves can be varied and/or controlled via electrical signals. Such an embodiment adds to the control flexibility of the present invention, in that the flow profiles can be varied as desired through the use of electrical control signals and the opening and closing profiles can be varied from each other effectively and simply. Therefore, in applications in which the operational profiles and parameters of the PDC assembly 100 will change significantly (making it difficult to chose an optimal geometry for the port 103 for all operational settings) it may be advantageous to use an embodiment in which electrical solenoids are used.

Thus, the rate at which power is supplied to the solenoid valves can be used to control the rate at which they open and close. In an exemplary embodiment of the present invention, the solenoid valves are actively opened and closed such that both their opening and closing is controlled. In a further embodiment, where the closing of the valve is not needed to be controlled or can be constant throughout operation a solenoid valve with active opening and passive closing can be used. In such a valve a spring, or like device, is used to automatically close the valve when the control signal is stopped.

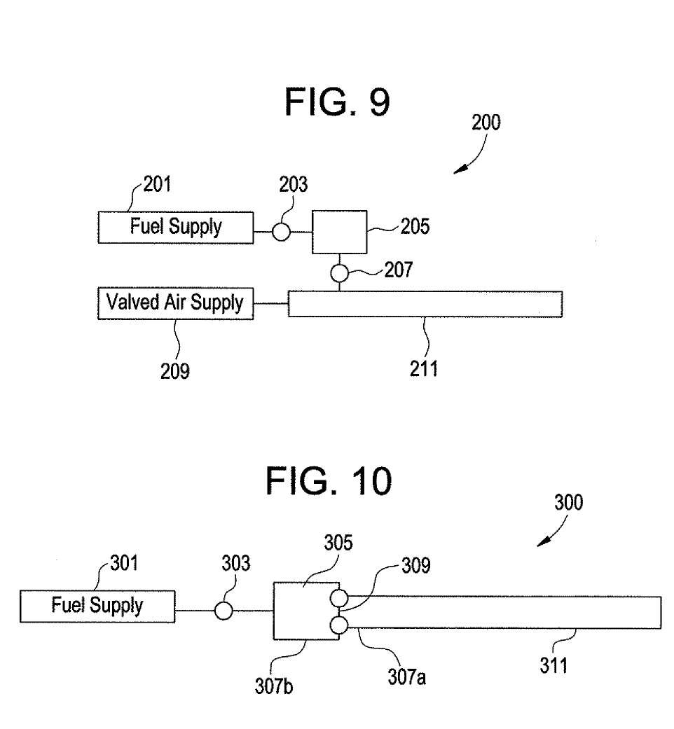

Turning now to FIG. 9 and PDC assembly 200 is shown in which an exemplary embodiment of a fuel flow control system is depicted. The air flow is supplied via a valved supply source 209 which can be in accordance with any exemplary embodiment described herein. In this exemplary embodiment, fuel is supplied from a fuel supply 201 and its flow is controlled via a fill valve 203. When the fill valve 203 is opened the fuel flows into a fuel plenum 205. When the fuel plenum reaches a set level (e.g., full) the fill valve 203 is closed, thus preventing backflow to the supply 201. Downstream of the fuel plenum 205 is an injection valve 207. After the fill valve 203 closes the injection valve 207 opens and the fuel plenum drains into the PDC tube 211.

As the fuel drains into the PDC tube 211 the pressure within the fuel plenum 205 (which is a closed system) drops. Because the pressure within the plenum 205 drops the fuel flow rate drops. This results in a fuel flow profile in which the fuel flow rate slows at the end of the fill, thus resulting in a lean equivalence ratio at the end of the fill stage. In such an embodiment, if it was desired to ignite the mixture at a location where the mixture was “rich” the ignition source can be placed in the tube 211 at the location where the mixture was rich. For example, the ignition source can be placed axially downstream from the fuel injection point where the mixture will be richer at ignition, than at the fuel ignition point, where it will be leaner at the conclusion of the fuel fill.

In a further exemplary embodiment, the injection valve 207 is a stepped or variable opening solenoid valve (that is a valve which opens to different positions at different control signals). In this embodiment during fuel fill the injection valve is opened to a first position, not its full open position, which creates a leaner equivalence ratio at the beginning of the fill process. As the fill process continues the injection valve 207 is opened further to provide additional/increased fuel flow, thus making the equivalence ratio. At the end of the fill process the valve 207 can be opened to a maximum position resulting in a highly rich mixture at the end of the fuel fill process. Of course, the present invention is not limited to this exact sequence. It is contemplated that various embodiments of the present invention control the injection valve 207 differently based on the desired fuel fill rates.

It is further noted that in the above described embodiment if the fuel plenum 205 has a large enough volume the fuel flow rate into the PDC tube 211 can become nearly constant (at a constant injection valve 207 opening). This is because the rate of change of the fuel volume within the plenum 205 with respect to the overall plenum volume will be relatively small. This allows for flow control to primarily come from the injection valve 207.

In another embodiment, the fuel plenum 205 can be under positive pressure such that when the injection valve 207 opens the fuel is positively injected into the PDC tube 211.

In a further embodiment, the fuel supply 201 and or the fuel system can be under a positive pressure such that the system employs a check valve (or other one way flow control device) and an electrically operated injection valve 207 to control the flow rate of fuel during the fill process.

FIG. 10 depicts another exemplary embodiment of the present invention, which can be employed to effect the equivalence ratio profile control/tailoring described herein. In this embodiment, a PDC assembly 300 contains a fuel plenum 305 coupled to a PDC tube 311 via a variable geometry valve 309. For purposes of this discussion the term “valve” is used to describe the variable geometry valve 309. However, it is also contemplated that a variable geometry nozzle can be used. The use of the term “valve” here, and elsewhere within this application, is not intended to exclude any other flow control devices, such as nozzles.

The variable geometry valve 309 opens and closes based on control signals from a controller, or the like.

During operation, fuel from a fuel supply 301 is directed through a fill valve 303 into the plenum 305. During the filling of the plenum 305 the valve 309 can either be open to a first position, in which a set amount of fuel is allowed to enter the PDC tube 311, or it can be closed preventing fuel from entering the PDC tube 311 completely. Even if the valve 309 is open to a first position the fuel fill rate in the plenum is such that the amount of fuel within the plenum 305 increases during the fill process.

Additionally, during the PDC fill stage air flow is directed into the PDC tube 311 via the primary valved air supply 307a (which can be configured as any of the embodiments described herein) and may or may not be directed into the plenum 305 via the secondary valved air supply 307b.

At a set point during the fuel fill process the entirety of the air flow is directed through the secondary valved air supply 307b into the plenum 305, resulting in a fuel rich mixture within the plenum 305. In an exemplary embodiment, the ignition source (not shown) is located within the plenum and when the plenum reaches the desired equivalence ratio ignition is initiated in the plenum 305. This results in a rapid pressurization within the plenum 305 resulting in a turbulent high speed flame jet passing through the valve 309 into the PDC tube 311. As this jet enters the PDC tube 311 the DDT process is initiated. Additionally, the valve 309 is opened to a second position, allowing for an increase in the flow into the PDC 311.

In an exemplary embodiment of the present invention, the early onset of turbulence in the PDC tube 311 from the valve 309 will reduce the DDT time.

In a further exemplary embodiment, an ignition source (not shown) is positioned within the PDC tube 311 to assist the DDT in the PDC tube 311.

In exemplary embodiments of the present invention, the variable geometry valve 309 is controlled so that its opening geometry is optimized throughout the operation of the PDC tube 311 to achieve optimal performance at varying operational conditions. Thus the geometry of the valve is changed to achieve the desired equivalence ratio profile within the plenum 305 and/or the PDC tube 311 to obtain the desired performance. Further, the valve 309 can be closed at the appropriate time to protect all upstream components from the high pressure waves resulting from the detonations within the PDC tube 311.

Because the described embodiments herein are extremely flexible in their operation, it is contemplated that the PDC tubes 311 can be operated in a standard combustion mode, in which an oxidizer and fuel are continuously fed into the PDC tube 311 to provide simple combustion, depending in the desired operation based on conditions.

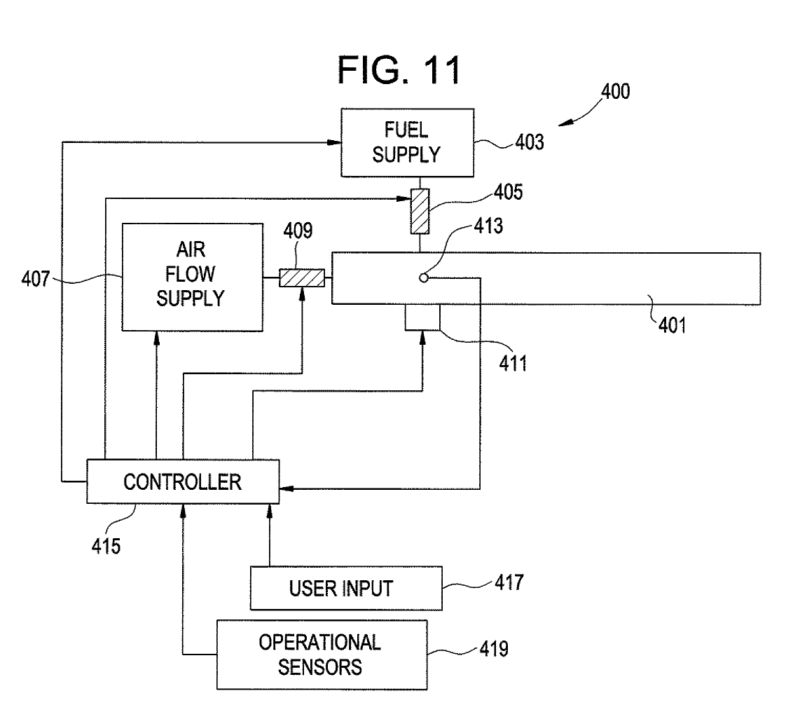

Turning now to FIG. 11, a non-limiting exemplary embodiment of a PDC control system 400 is depicted. The system 400 includes at least one PDC tube 401 which receives fuel from a fuel system 403 and air flow from an air flow supply 407. It is noted that the fuel supply 403 and air flow supply 407 can be as described herein, or can be any known or conventional system.

Each of the fuel supply 403 and air flow supply 407 are coupled to the PDC tube 401 via electrically controlled solenoid valves 405 and 409, respectively. (Alternatively, other types of actuators, such as pneumatic, can be used.) The valves 405 and 409 can be active open and close type solenoid valves, stepper/variable opening valves, active open/passive close type valves, or the like. These valves 405/409 are controlled by controller 415 to ensure that a desired equivalence ratio profile is employed within the PDC tube 401.

In the embodiment shown in FIG. 11 each of the fuel supply 403 and the air flow supply 407 receive control signals from the controller 415. However, in other exemplary embodiments, this control is not necessary. In yet a further exemplary embodiment, each of the fuel supply 403 and the air flow supply 407 provide data and/or feedback to the controller 415 which is used by the controller to optimize performance of the system 400 and ensure that each of the supplies are function as desired.

It is further noted that, although the embodiment shown in FIG. 11 employs solenoid valves 405/409, these components can be replaced with any of the flow control mechanisms described herein (above). For example, the valve 409 can be replaced with valve assembly 107 from FIGS. 5, 7 and 8 and the fuel valve 405 can be replaced with the fuel injection valve 207 from FIG. 9. In such an embodiment, for example, rather than controlling the valve 409 the controller controls the motor (not shown) which turns the portion 109 in the FIGS. 5, 7 and 8 embodiments. Additionally, valves 405/409 can be replaced with the embodiment shown in FIG. 10. Therefore, the configuration shown in FIG. 11 is intended to exemplary and demonstrative in that any of the contemplated embodiments herein can be employed and controlled by the controller 415 as described herein to achieve the desired equivalence ratio profile and/or PDC operation.

Coupled to the PDC tube 401 is an ignition source 411. The ignition source can be of any known type, such as a spark or plasma source. The ignition source 411 is controlled by the controller 415 to initial detonation within the PDC tube 401. The ignition source 411 is located within the PDC tube 401 at a location to ensure its proper placement within the tube's 401 axial equivalence ratio profile so as to ensure optimal DDT during operation. Adjacent the ignition source 411, within the PDC tube 401 is a sensor 413. The sensor 413 provides feedback to the controller 415. In an exemplary embodiment of the present invention, the sensor 413 is an equivalence ratio sensor that detects the equivalence ratio within PDC tube 401 at or near the ignition source 411. This feedback is used by the controller 415 to control the operation of the valves 405/409 and/or the supplies 403/407, depending on the embodiment.

Although a single sensor 413 is depicted in FIG. 11, it is noted that additional sensors can be employed to provide additional feedback to the controller. For example, it is contemplated that pressure, temperature, fuel, and/or oxidizer sensors can be employed to provide additional feedback to the controller 415 as desired.

The embodiment shown in FIG. 1 also includes a user input 417 and other operational sensors 419 which provide input to the controller 415. In other embodiments either one or both of these input sources are removed as unnecessary. However, in the depicted embodiment the user input 417 provides input from the user to the controller 415, such as a throttle or power setting, so that the controller 415 can appropriately control operation of the valves 405/409 and/or supplies 407/403 to ensure proper operation of the PDC tube 401 and that a proper equivalence ratio profile is employed.

The operational sensors 419 provide additional feedback to the controller 415 so that the controller 415 can properly tune/operate the system 400. For example, the operational sensors can detect ambient air pressure, temperature, humidity, or whatever factors are deemed to be needed for the controller 415 to optimize the equivalence ratio profile within the PDC tube 401 for optimal operation.

The controller 415 is any known or conventional CPU, microprocessor or the like which is capable of controlling the valves 405/409 and/or the supplies 403/407 using either algorithms, programming, and/or look up tables, etc. The controller 415 can use the feedback shown in FIG. 11 or, in other embodiments, operate absent feedback, such as in a constant setting configuration.

It is noted that although the present invention has been discussed above specifically with respect to aircraft and power generation applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. A pulse detonation combustion system, comprising:
at least one pulse detonation combustor tube;
an air flow valve which directs an air flow into said at least one pulse detonation combustor tube, wherein said air flow assembly changes a rate of change of said air flow into said pulse detonation combustor tube during a fill stage of said pulse detonation combustor tube;
a fuel flow control valve which directs fuel to said at least one pulse detonation combustor tube; and
wherein said air flow valve controls said air flow rate of change with respect to a fuel flow rate of change provided by said fuel flow control valve to control the equivalence ratio within said pulse detonation combustor tube.

2. The pulse detonation combustion system of claim 1, wherein said air flow valve comprises a rotating portion having at least one air flow port through which said air flow passes into said at least one pulse detonation combustor tube, and
wherein rotation of said rotating portion controls said equivalence ratio within said at least one pulse detonation combustor tube.

3. The pulse detonation combustion system of claim 2, wherein said at least one air flow port has a main portion and at least one of a leading edge portion and a trailing edge portion extending from said main portion, wherein said main portion has a shape which corresponds to a shape of an inlet to said at least one pulse detonation tube.

4. The pulse detonation combustion system of claim 3, wherein said main portion substantially dimensionally matches said inlet.

5. The pulse detonation combustion system of claim 3, wherein said either leading edge or trailing edge has an edge contour which matches a contour of said inlet.

6. The pulse detonation combustion system of claim 2, wherein rotation of said rotating portion controls said flow rate of change of said air into said at least one pulse detonation combustor tube with respect to a fuel flow rate of change from said fuel flow control valve.

7. The pulse detonation combustion system of claim 2, wherein said rotating portion comprises a plurality of said air flow ports.

8. The pulse detonation combustion system of claim 2, wherein a rate of rotation of said rotating portion changes during a single rotation of said rotating portion to change said rate of change of said air flow.

9. The pulse detonation combustion system of claim 3, wherein said at least one air flow port comprises both a leading edge portion and trailing edge portion and a shape of said leading edge portion is different from a shape of said trailing edge portion.

10. The pulse detonation combustion system of claim 1, further comprising a fuel flow control device which controls a rate change of said fuel flow into said at least one pulse detonation combustor device.

11. The pulse detonation combustion system of claim 2, further comprising a fuel flow control device which controls a rate change of said fuel flow into said at least one pulse detonation combustor device.

12. The pulse detonation combustion system of claim 2, further comprising at least one sensor coupled to said at least one pulse detonation combustor and at least one of a rate of rotation of said rotating portion and a rate of change of said fuel flow is controlled based on feedback from said sensor.

13. The pulse detonation combustion system of claim 1, wherein said rate of change of said air flow is controlled such that said equivalence ratio is rich adjacent to an ignition source within said at least one pulse detonation tube at the end of a fill cycle of said at least one tube.

14. A pulse detonation combustion system, comprising:
at least one pulse detonation combustor tube;
an air flow valve which directs an air flow into said at least one pulse detonation combustor tube, wherein said air flow assembly changes a rate of change of said air flow into said pulse detonation combustor tube during a fill stage of said pulse detonation combustor tube;
a fuel flow control valve which directs fuel to said at least one pulse detonation combustor tube; and
wherein said air flow valve comprises a rotating portion having at least one air flow port through which said air flow passes into said at least one pulse detonation combustor tube,
wherein rotation of said rotating portion controls an equivalence ratio within said at least one pulse detonation combustor tube such that said equivalence ratio is maintained constant for at least 50% of the fill of said at least one pulse detonation combustor.

15. The pulse detonation combustion system of claim 14, wherein said at least one air flow port has a main portion and at least one of a leading edge portion and a trailing edge portion extending from said main portion, wherein said main portion has a shape which corresponds to a shape of an inlet to said at least one pulse detonation tube.

16. The pulse detonation combustion system of claim 15, wherein said main portion substantially dimensionally matches said inlet.

17. The pulse detonation combustion system of claim 15, wherein said either leading edge or trailing edge has an edge contour which matches a contour of said inlet.

18. The pulse detonation combustion system of claim 14, wherein rotation of said rotating portion controls said flow rate change of air into said at least one pulse detonation combustor tube with respect to a fuel flow rate from said fuel flow control valve.

19. The pulse detonation combustion system of claim 14, wherein said rotating portion comprises a plurality of said air flow ports.

20. The pulse detonation combustion system of claim 14, wherein a rate of rotation of said rotating portion changes during a single rotation of said rotating portion to change said rate of change of said air flow.

21. The pulse detonation combustion system of claim 15, wherein said at least one air flow port comprises both a leading edge portion and trailing edge portion and a shape of said leading edge portion is different from a shape of said trailing edge portion.

22. The pulse detonation combustion system of claim 14, further comprising a fuel flow control device which controls a rate of change of fuel flow into said at least one pulse detonation combustor device.

23. The pulse detonation combustion system of claim 14, further comprising at least one sensor coupled to said at least one pulse detonation combustor and at least one of a rate of rotation of said rotating portion and a rate of change of fuel flow is controlled based on feedback from said sensor.

24. The pulse detonation combustion system of claim 14, wherein rotation of said rotating portion controls an equivalence ratio within said at least one pulse detonation combustor tube such that said equivalence ratio is maintained constant for at least 90% of the fill of said at least one pulse detonation combustor.
